(19) United States
(12) Patent Application Publication
(10) Pub. No.: US 2016/0342574 A1
(43) Pub. Date: Nov. 24, 2016

(54) ALLOTMENT OF PLACEMENT LOCATIONS FOR SUPPLEMENTAL CONTENT IN DYNAMIC DOCUMENTS

(71) Applicants: Xincheng Zhang, Sunnyvale, CA (US); Dongmin Zhang, San Jose, CA (US); Jia Liu, Sunnyvale, CA (US)

(72) Inventors: Xincheng Zhang, Sunnyvale, CA (US); Dongmin Zhang, San Jose, CA (US); Jia Liu, Sunnyvale, CA (US)

(21) Appl. No.: 13/653,170

(22) Filed: Oct. 16, 2012

(51) Int. Cl. G06F 17/21

(52) U.S. Cl. CPC G06F 17/22

(57) ABSTRACT

Systems and methods for determining a layout for display of a dynamic document. The system and methods generally include a data processing system configured to determine an allotment of placement locations for supplemental content based on an identified size characteristic of principal content in a requested dynamic document. The data processing system determines a layout for display of the principal content and supplemental content objects according to the determined allotment of placement locations and provides the determined layout responsive to notification of the request. The data processing system may position placement locations for supplemental content according to the determined allotment of placement locations, positioning placement locations in regions inset within a principal content region, adjacent to a principal content region, in a region configured to remain within a view, or in a region configured to float above or around a principal content region.

### BACKGROUND

A document is a mechanism for delivering visual information. A dynamic document delivers visual information in a form that is constructed on demand, for example, in response to a request for specific content. Examples of dynamic documents include both physical documents printed on demand and electronic documents, such as web pages. Generally, a dynamic document includes content pulled from multiple categories or sources. For example, a dynamic document may include both principal content specific to the document and publisher content generic to the document but specific to the publisher. Supplemental content may also be added to the dynamic document to enhance the dynamic document beyond the principal content.

An example of a dynamic document, which may be used electronically or printed, is an article from a news-oriented website. The publisher content may be a page header featuring the name and logo of the news company, a site navigation menu, and a page footer including a copyright notice. The principal content may be the particular article or news story. The supplemental content may include additional media related to the principal content, a block of current headlines, a current stock report, a local weather report, or advertisements.

Presently existing approaches to dynamic documents are generally inflexible with respect to the amount of supplemental content that can be displayed along with a particular principal content item. As a result, the principal content of a dynamic document may be divided into multiple pages. For example, a website may split a lengthy article into multiple portions, each presented as a separate web page, in order to present additional items of supplemental content along with the principal content item. This has an unfortunate impact on users, networks, and servers. It is therefore desirable to provide a greater level of flexibility in the content and layout of a dynamic document.

### SUMMARY OF THE INVENTION

Aspects and implementations of the present disclosure are directed to systems and methods of determining an allotment of placements for supplemental content in dynamic documents. In general, in some implementations, a data processing system receives notification of a request for a dynamic document, accesses principal content for the dynamic document, determines a size characteristic for the principal content, determines an allotment of placement locations for supplemental content based on the determined size characteristic, determines a layout for display of the principal content and supplemental content objects, and provides the determined layout.

At least one aspect is directed to computer implemented methods of determining a layout for display of a dynamic document. The methods include receiving, by a data processing system, notification of a request for a dynamic document and accessing, by the data processing system, principal content for the dynamic document. The methods include determining a size characteristic of the principal content and determining an allotment of placement locations for supplemental content based on the determined size characteristic of the principal content. The methods include determining a layout for display of the principal content and supplemental content objects according to the determined allotment of placement locations and providing the determined layout responsive to the notification of the request.

The methods may include fetching the principal content, by the data processing system, from a second data processing system. Size characteristics of the principal content may be one or more of a number or characters, i.e., a character count, a number of words, i.e., a word count, a number of text lines, i.e., a line count, a number of image pixels in a media object, i.e., a pixel count, a media dimension, and/or a media element count. The methods may include receiving, by the data processing system, an indicator of a size characteristic of a display space and determining the size characteristic of the display space, wherein determining the allotment of placement locations may be further based at least on the size characteristic of the display space. The methods may include determining the layout for display of the principal content and supplemental content objects based at least on the size characteristic of the display space.

The methods may include determining the layout, in part, by positioning placement locations for supplemental content according to the determined allotment of placement locations. Example positioning placement locations include positioning at least one placement location in a region that is one of: a region inset within a principal content region; a region adjacent to a principal content region; a region configured to remain within a view; or a region configured to float, e.g., above or around a principal content region.

At least one aspect is directed to a system for determining a layout for display of a dynamic document, the system comprising a data processing system including at least a document layout module. Generally, the data processing system is configured to receive a notification of a request for a dynamic document, identify a size characteristic of the principal content, determine an allotment of placement locations for supplemental content based on the identified size characteristic of the principal content, determine, using the document layout module, a layout for display of the principal content and supplemental content objects according to the determined allotment of placement locations, and provide, responsive to the notification of the request, the determined layout.

The system may include a document analysis module. The data processing system may be configured to fetch the principal content from a second data processing system and, using the document analysis module, identify the size characteristic through an analysis of the fetched principal content. The data processing system may be configured to receive an indicator of a size characteristic of a display space and determine the size characteristic of the display space. The data processing system may be configured to determine the allotment of placement locations based at least on the size characteristic of the display space. The document layout module may be configured to determine the layout for display of the principal content and supplemental content objects based at least on the size characteristic of the display space. The document layout module may be further configured to determine the layout by positioning placement locations for supplemental content according to the determined allotment of placement locations.

At least one aspect is directed to non-transitory computer-readable storage media storing processor executable instructions, which, when executed by one or more processors, cause the one or more processors to receive a notification of a request for a dynamic document, identify a size characteristic of the principal content, determine an allotment of placement locations for supplemental content based on the identified size characteristic of the principal content, determine a layout for display of the principal content and supplemental content objects according to the determined allotment of placement locations, and provide the layout responsive to the request.

The computer-readable storage media may store instructions further causing the processors to receive an indicator of a size characteristic of a display space, determine the size characteristic of the display space, determine the allotment of placement locations based at least on the size characteristic of the display space, and determine the layout for display of the principal content and supplemental content objects based at least on the size characteristic of the display space.

The computer-readable storage media may store instructions further causing the processors to determine the layout by positioning placement locations for supplemental content according to the determined allotment of placement locations. Positioning placement locations may include positioning at least one placement location in a region that is one of: a region inset within a principal content region; a region adjacent to a principal content region; a region configured to remain within a view; and a region configured to float.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is a block diagram illustrating an example environment to evaluate information on a computer network, according to an illustrative implementation;

FIG. 2 is a block diagram illustrating an example computer system that may be employed to implement various elements of the systems and methods described and illustrated herein, according to an illustrative implementation;

FIGS. 3A, 3B, 3C, and 3D are block diagrams illustrating examples of dynamic documents;

FIG. 4 is a flow diagram illustrating a method of determining a layout for display of a dynamic document;

FIG. 5 is a flow diagram illustrating a method of determining a layout for display of a dynamic document with dynamically determined supplemental content objects; and

FIG. 6 is a flow diagram illustrating a method of determining a layout for display of a dynamic document with dynamically displayed supplemental content objects.

### DETAILED DESCRIPTION

Following below are more detailed descriptions of various concepts related to, and implementations of, methods of, apparatuses for, and systems for determining an allotment of placements for supplemental content in a dynamic document. The various concepts introduced above and discussed in greater detail below may be implemented in any of numerous ways, as the described concepts are not limited to any particular manner of implementation. Although this disclosure focuses on web pages as exemplary dynamic documents, alternative dynamic documents may make use of the novel features described herein without departing from the scope of the invention. Examples of specific implementations and applications are provided primarily for illustrative purposes.

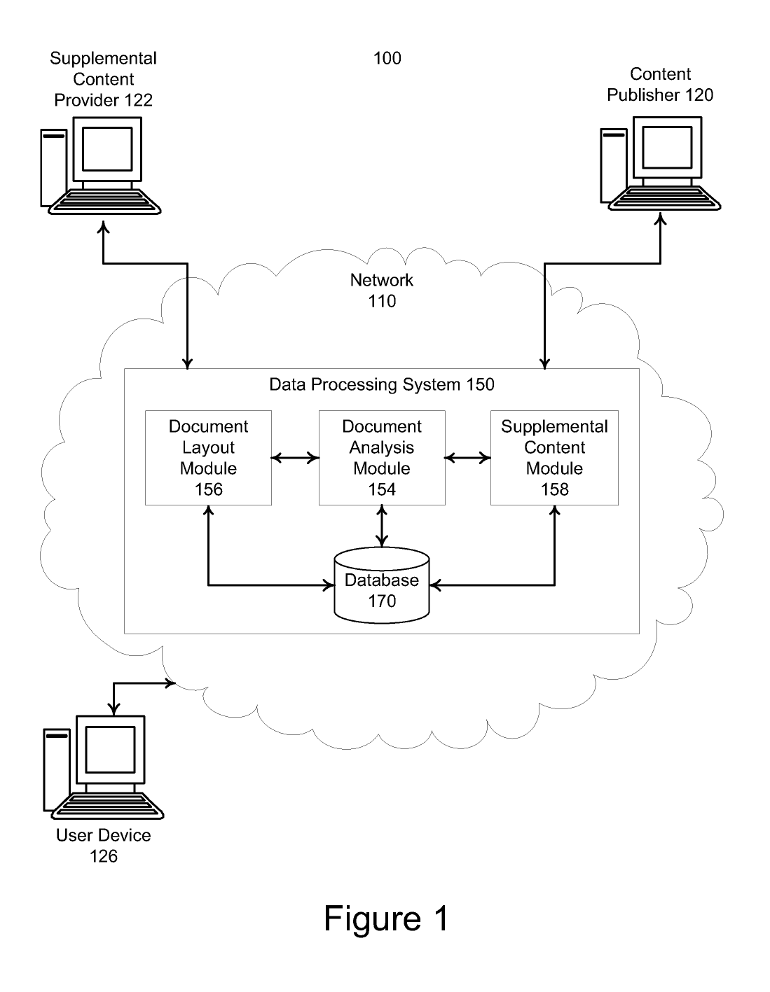

FIG. 1 illustrates an example system 100 for providing a dynamic document to a user device 126 via a computer network such as network 110 according to an implementation of the present disclosure. The network 110 can include computer networks such as the Internet, local, metro, or wide area networks, intranets, and other communication networks such as mobile telephone networks. The network 110 can be used to access dynamic documents that can be displayed on at least one user device 126, such as a laptop, desktop, tablet, electronic pad, personal digital assistant, smart phone, television, kiosk, or portable computer. For example, via the network 110, a user of the user device 126 can access dynamic documents delivered as web pages provided by a content publisher 120. In this example, the user device 126 uses software, such as a web browser, to access a web server and retrieve a web page for display by the user device 126. The web server may be the content publisher 120 or an intermediary host.

The system 100, as illustrated, includes at least one data processing system 150, which includes at least one processor or other logic device to communicate via the network 110 with at least one content provider 120 and at least one supplemental content provider 122. The example data processing system 150 shown includes a document analysis module 154 configured to analyze content requested via the network 110, a document layout module 156 configured to determine a layout for a dynamic document, a supplemental content module 158 configured to select supplemental content for delivery with principal content in a requested dynamic document, and at least one data repository or database 170. The data processing system 150 can include or communicate with a content selection server, a content host server, a content placement server, and other data processing systems.

The data processing system 150 includes an interface configured to receive notification of a request via the network 110 for a dynamic document. In some implementations, the data processing system 150 receives the request and processes the request, serving the document, or issuing subsequent requests causing the document to be served, to the requesting device, e.g., the user device 126. In some implementations, the data processing system 150 receives notification of the request from another data processing system. For example, a dynamic document server may request a layout from the data processing system 150.

The document analysis module 154 analyzes content requested via the network 110. In some implementations, the document analysis module 154 fetches principal content for a dynamic document. In some implementations, the document analysis module 154 uses document indicators, e.g., a uniform resource locator (“URL”) or database key, to retrieve analytical information about the principal content for a document, e.g., without fetching the actual principal content. For example, the data processing system 150 may access a content database and retrieve information about the requested principal content. In some implementations, the document analysis module 154 extracts information about the principal content from document indicators directly. For example, the number of words in an text document, e.g., an article, may be embedded in the URL for the document. That is, a document identifier may include a word count, line count, or other indicator.

The document layout module 156 determines a layout for a dynamic document. The layout module 156 may generate the layout using templates, layout subcomponents, Cascading Style Sheets, XML elements, HTML elements, or other layout structures and objects. The layout may rely on server-side or client-side scripts, for example, Perl, Ruby, Rails, PHP, JavaServer Pages (JSP), Javascript, Flex, Flash, or AJAX. Portions of the layout may be determined in reference to content elements, e.g., publisher content, principal content, or supplemental content. In some implementations the layout may be a webpage. The layout may specify a set of URLs, each URL pointing to additional layout information or content information. In some implementations, the document layout module 156 selects a layout from a collection of pre-determined layouts, e.g., based on a dynamic document-specific factor. For example, the document analysis module 154 may determine that a dynamic document is to feature three supplemental content objects and the document layout module 156 may select a pre-determined layout designed with three placement locations for supplemental content.

In some implementations, the document layout includes active layout functionality to expand or contract the layout. The active layout functionality enables the layout to adjust the allocation of supplemental content regions or placement locations according to a set of parameters or rules. For example, a layout may be selected or generated with an initial allotment of placement locations for supplemental content and a set of rules for adding or removing additional placement locations. The allotment of placement locations may be altered by active layout functionality, embedded in the layout, in response to a change in display window size or in response to a change in a size characteristic of the principal content. In some implementations, the active layout functionality is provided using Flex, Flash, Java, Javascript, or AJAX. The initial allotment of placement locations may be determined by the document analysis module 154 or may be a default number. In some implementations, the layout includes the document analysis module 154. In some implementations, the active layout functionality includes a document analysis module embedded in the layout.

In some implementations, the document analysis module 154 may be unable to determine an allotment of placement locations specific to the principal content when the layout is first requested. The layout module 156 may select or generate a layout with a default allotment of placement locations and active layout functionality to add or remove placement locations when an appropriate allotment can be determined. The determination may be made by a functional component of the layout, e.g., according to a set of parameters or rules, or by the document analysis module 154 in a delayed manner. For example, the layout may include a functional component communicating with the document analysis module 154, which may determine an allotment of placement locations after the initial layout has been selected or generated. The document analysis module 154 may be unable to determine an allotment of placement locations, for example, if the principal content is itself dynamic. The principal content may be a real-time transcript of a live event such that the size characteristic increases over time. The document analysis module 154 may be unable to determine an allotment of placement locations, for example, if the document analysis module 154 does not have access to the principal content. The layout may be configured to submit the principal content to the document analysis module 154.

In some implementations, one or both of the document analysis module and document layout module are executed at the user device 126. For example, one or both modules are implemented in computer executable code, e.g., using one of the scripting languages above, and are passed to the user device as part of the requested dynamic document for execution local to the user device 126. In some implementations, the execution is carried out in cooperation with other modules operating at the data processing system 150. The layout may be configured to adjust the allotment of placement locations, e.g., as described above, in response to the analysis at the user device 126.

The supplemental content module 158 selects supplemental content objects for delivery with principal content in a requested dynamic document. For example, the supplemental content module 158 may analyze the principal content and determine one or more supplemental content objects relevant to the principal content or likely to be relevant to a user requesting the principal content. The supplemental content module 158 may select supplemental content objects based on a variety of factors including relevance, business objectives, time of day, number of supplemental content objects to be selected, and the content or nature of other supplemental content objects selected. In some implementations, the supplemental content module 158 selects supplemental content in conjunction with the document layout module 156. For example, the supplemental content module 158 may select supplemental content objects based on space allocated by the document layout module 156. In some implementations, the document layout module 156 may allocate space for a particular supplemental content object selected by the supplemental content module 158.

In some implementations, the document analysis module 154, document layout module 156, and the supplemental content module 158 are special purpose logic circuits, e.g., application-specific integrated circuits (ASICs). In some implementations, the modules include one or more processors executing instructions encoded as firmware or software on communicatively coupled computer-readable media.

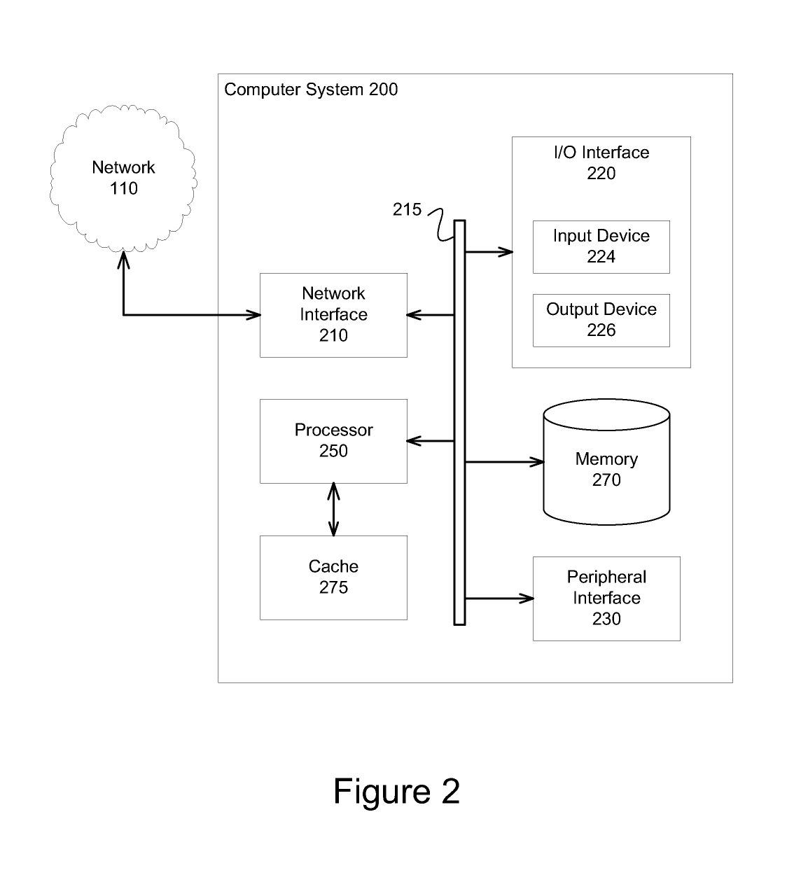

FIG. 2 illustrates an example computer system 200 suitable for use in implementing the computerized components of the system 100. The example computer system 200 includes one or more processors 250 in communication, via a bus 215, with one or more network interfaces 210 (in communication with the network 110), I/O interfaces 220 (for interacting with the user), and memory 270. The processor 250 incorporates, or is directly connected to, additional cache memory 275. In some uses, additional components are in communication with the computer system 200 via a peripheral interface 230. In some uses, such as in a server context, there is no I/O interface 220, or the I/O interface 220 is not used.

In some implementations, the user device 126 illustrated in FIG. 1 is constructed to be similar to the computer system 200 of FIG. 2. For example, a user interacts with an input device 224, e.g., a keyboard, mouse, or touch screen, to request a dynamic document, e.g., a web page, to be delivered over the network 110, received at interface 210, and output via output device 226, e.g., a display, screen, touch screen, or speakers. The request can be processed by the data processing system 150, which determines a layout for the dynamic document and, in some implementations, identifies supplemental content from provider 122 for delivery with content from publisher 120.

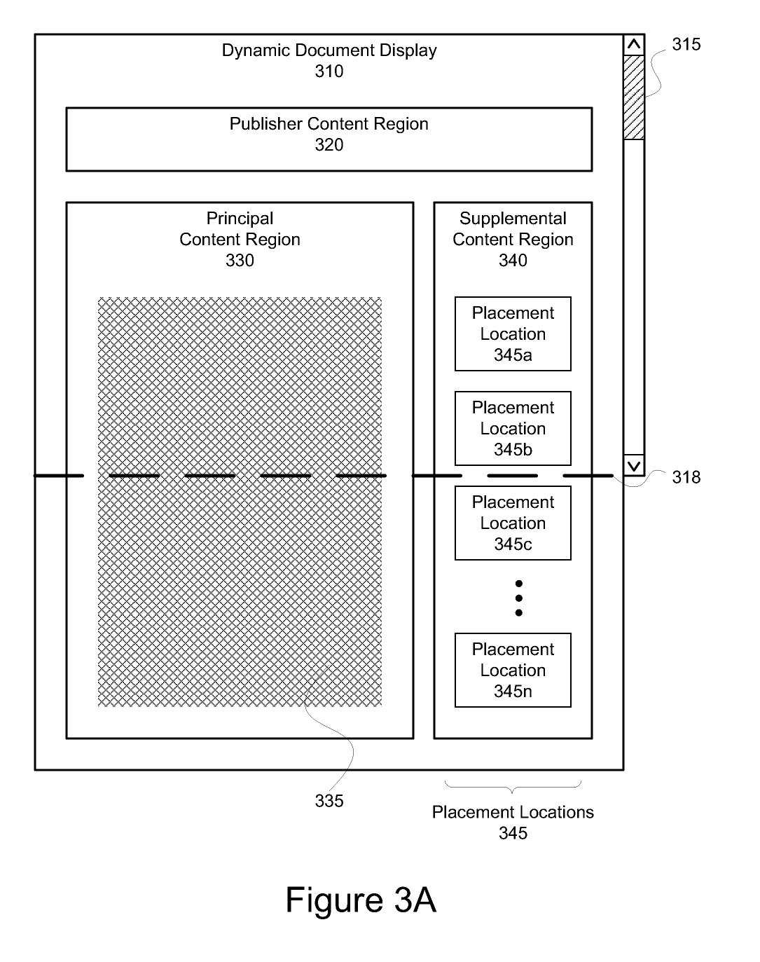

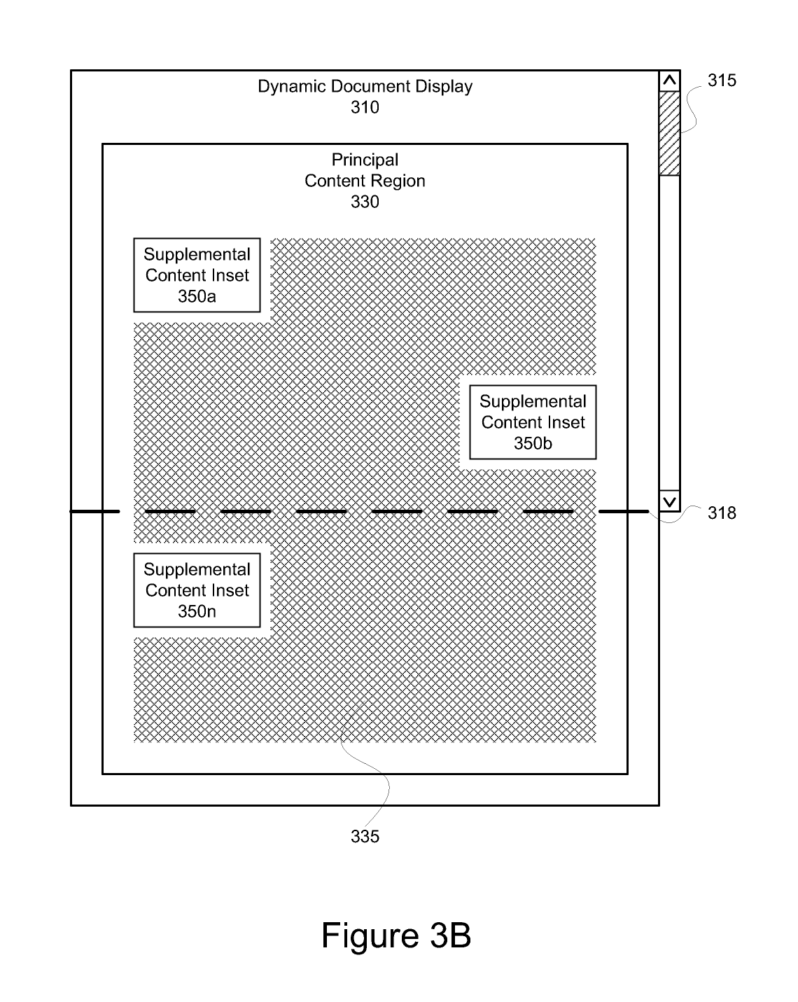

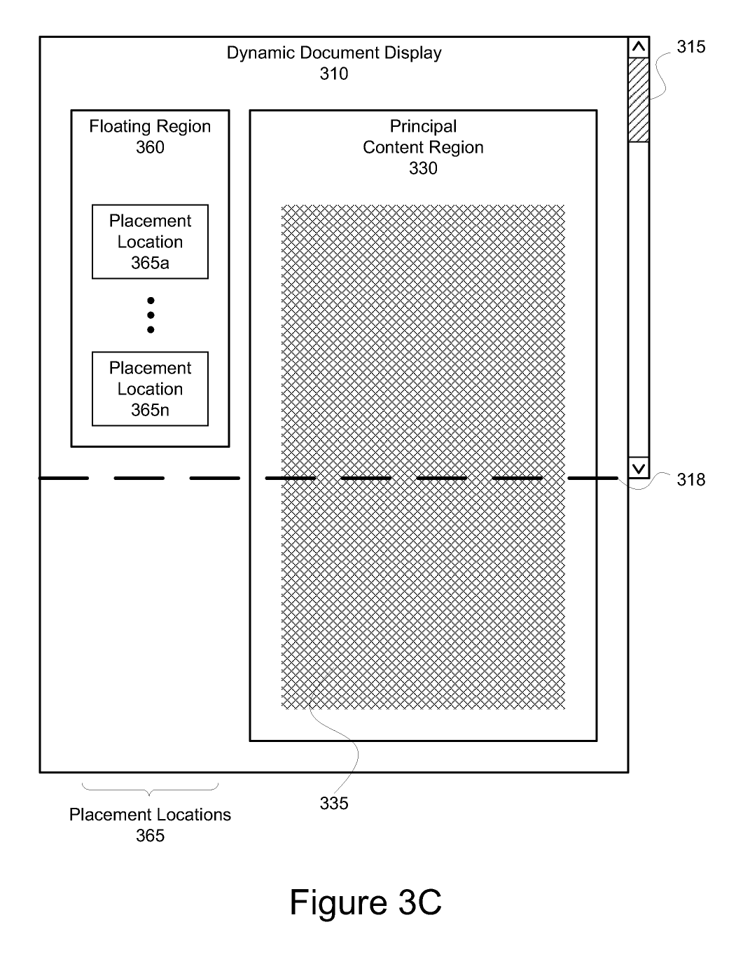

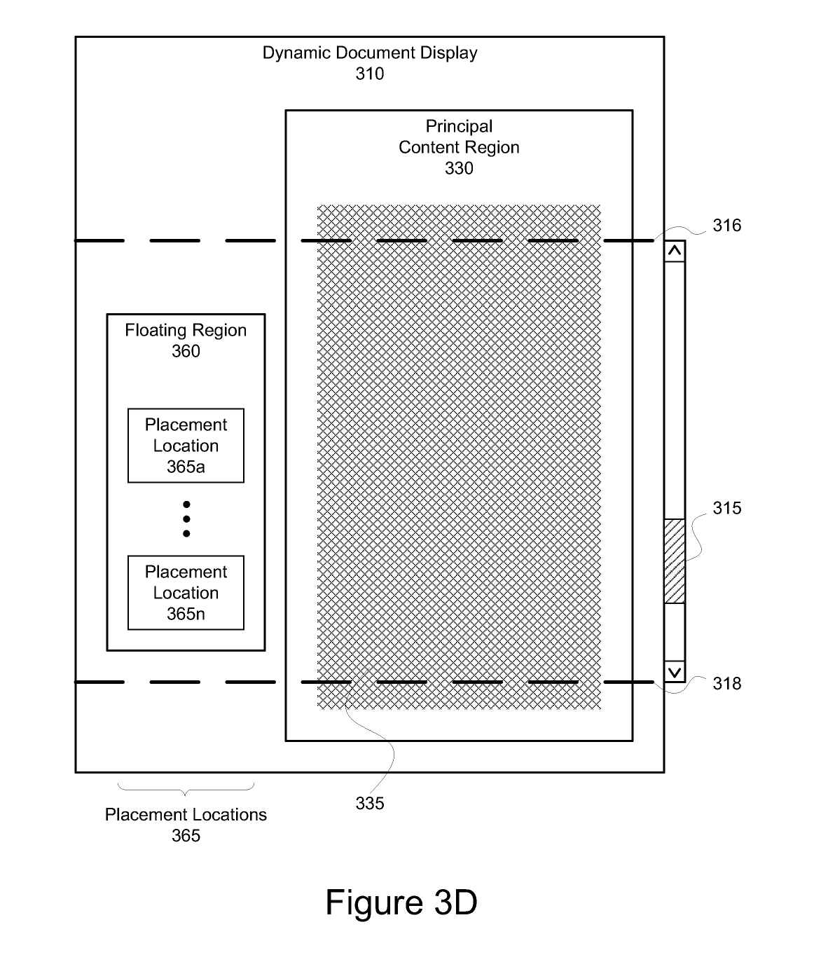

FIGS. 3A-3D illustrate examples of dynamic documents and manners in which a dynamic document may be displayed. Each of the figures includes a dynamic document display 310 representative of the display space for the dynamic document. In some implementations, the dynamic document display 310 is the display window of a web browser. As illustrated, the dynamic document display 310 may include more material than may be displayed at one time within the constraints of the display. The upper and lower bounds of the display are indicated in the figures using horizontal dashed lines. The example displays illustrated are simplified and omit reasonable variations that may include, for example, multiple publisher content regions, multiple principal content regions, multiple supplemental content regions, alternative locations and orientations of the various content regions with regard to other content regions, a horizontal scroll bar, and additional or fewer scroll bars. These and other variations do not depart from the scope of the disclosure.

FIG. 3A illustrates an example of a dynamic document. The document is presented via a dynamic document display 310. The document is composed of various content regions, e.g., a publisher content region 320, a principal content region 330, and a supplemental content region 340. Each region is populated with the appropriate content, e.g., principal content 335 populates the principal content region 330. The supplemental content region 340 is illustrated as being subdivided into multiple placement locations 345, which may be populated with distinct supplemental content objects. The example display 310 supports scrolling through documents larger than the display using a scroll bar 315, for example where the dashed line 318 represents the bottom of the visual display area, as described further below.

The dynamic document display 310 is any mechanism for presenting a dynamic document. The material displayed by the dynamic document display 310 constitutes the dynamic document. In some implementations, the dynamic document display 310 may be, for example, a web browser. The display 310 may be presented to a user via a user device 126. The display 310 may be configured to support printing of the dynamic document. The display 310 may be a window in a user interface supporting multiple interface windows. The display 310 may be a set of windows in a user interface supporting multiple interface windows, e.g., where each region 320, 330, 340, is a distinct window.

A scroll bar 315 is illustrated as a mechanism for scrolling through the document presented in the dynamic document display 310. The illustration includes a dashed line 318 such that the portion of the document above the dashed line is visible to a user while the portion below the dashed line is not. A user may activate the scroll bar 315 to adjust the display, e.g., raising the portion below the dashed line 318 into view. In some implementations, only a sub-set of the content regions move when the scroll bar 315 is activated.

The publisher content region 320 is the portion of the dynamic document populated with publisher content. For example, publisher content may be a title splashed across the top of the document. A set of documents published by one publisher may have consistent publisher content across the set of documents. For example, a newspaper web site may have multiple pages, e.g., one for each article, and may place the newspaper title and a set of menu options at the top of each web page. In this example, the title and menus may populate publisher content region 320 while each article is the principal content 335 used to populate the principal content region 330 for each respective article page. The publisher content region 320 is illustrated as an example of consistent content across multiple documents from the same publisher. In some implementations, the publisher content is included in a template. In some implementations, there is no publisher content region 320 or the publisher content is folded in with the principal content and shown in a principal content region 330.

The principal content region 330 is the portion of the dynamic document populated with the principal content 335. Generally, although not necessarily, the principal content region 330 is the primary feature of the document. While the principal content region 330 is shown in FIG. 3A as being on the left side of the dynamic document display 310, it could be placed anywhere within the display. For example, the principal content region 330 could be in the middle of the display 310 (as in FIG. 3B) or on the right side of the display 310 (as in FIG. 3C and FIG. 3D). In some implementations, multiple principal content regions are displayed, e.g., a left region and a right region.

The supplemental content region 340 is the portion of the dynamic document populated with supplemental content. The Supplemental content region 340 is illustrated in FIG. 3A as being subdivided into multiple placement locations 345, which may each be populated with distinct supplemental content objects. There may be up to N distinct placement locations 345a-345n, where N is the allotment of supplemental placement locations for the supplemental region 340. The allotment of supplemental placement locations may be determined, for example, by the data processing system 150. The allotment of supplemental placement locations may be determined responsive to the principal content 335 of the dynamic document. For example, the allotment of supplemental placement locations may be determined in reference to the size or length of the principal content 335 such that fewer supplemental placement locations may be displayed with shorter principal content than might be displayed with longer principal content. The allotment of supplemental placement locations may depend upon the size of the supplemental content region 340. The allotment of supplemental placement locations may depend upon the size of the supplemental content objects to be displayed in each of the placement locations 345a-345n.

FIG. 3B illustrates a variation of the example dynamic document illustrated in FIG. 3A. The document is presented via a dynamic document display 310. The document is divided into regions, e.g., a principal content region 330 and multiple supplemental content inset regions 350a-350n. The principal content 335 is displayed in principal content region 330 and flows around the supplemental content insets 350a-350n. The example display 310 supports scrolling through documents larger than the display using a scroll bar 315, for example where the dashed line 318 represents the bottom of the visual display area. A user may activate the scroll bar 315 to adjust the display, e.g., raising the portion below the dashed line 318 into view. In this manner, the supplemental content insets below the dashed line 318, e.g., the lowest supplemental content inset 350n, become visible to the user.

Each of the supplemental content insets 350a-350n is a portion of the dynamic document populated with supplemental content. In some implementations, there may be up to N distinct supplemental content insets 350a-350n, where N is the allotment of supplemental placement insets for the dynamic document. The allotment of supplemental placement insets may be determined, for example, by the data processing system 150. The allotment of supplemental placement insets may be determined responsive to the principal content 335 of the dynamic document. For example, the allotment of supplemental placement insets may be determined in reference to the size or length of the principal content 335 such that fewer supplemental placement insets may be displayed with shorter principal content than might be displayed with longer principal content. The allotment of supplemental placement insets may depend upon the size of each of the supplemental content insets 350a-350n. The allotment of supplemental placement insets may depend upon the size of the supplemental content objects to be displayed in each of the supplemental content insets 350a-350n.

FIG. 3C illustrates a variation of the example dynamic document illustrated in FIG. 3A. The document presented via the dynamic document display 310 is composed of various content regions, e.g., principal content region 330 and floating region 360. Each region is populated with the appropriate content, e.g., principal content 335 populates the principal content region 330. The floating region 360 is illustrated as being subdivided into multiple placement locations 365a-365n, which may be populated with distinct supplemental content objects. As a user adjusts the display via scroll bar 315, the principal content 335 displayed moves while the supplemental content displayed in the floating region 360 appears to remain unmoved. In some implementations, as the principal content 335 is scrolled, the supplemental content displayed within the floating region 360 is changed, e.g., in reference to principal content 335 within the display window or in reference to a percentage of the principal content 335 viewed. In some implementations, as the principal content 335 is displayed, the supplemental content displayed within the floating region 360 is changed based on the passage of time. In some implementations, the dynamic document display 310 is composed of multiple floating regions. In some implementations, the dynamic document display 310 is composed of one or more of publisher content regions, principal content regions, supplemental content regions, supplemental content insets, and floating regions. Any of these regions may be implemented to float or not float. The principal content 335 may be made to flow around any of the regions, including floating regions.

FIG. 3D illustrates a variation of the example dynamic document illustrated in FIG. 3C. The document presented via the dynamic document display 310 is illustrated as viewed after activation of the scroll bar 315. An upper dashed line 316 and lower dashed line 318 illustrate the upper and lower bounds of the view, respectively. While a different portion of the principal content region 330 is within the view, the floating region 360 remains in the view. It's location in the display 310 respective to the display remains unchanged. The result is the appearance that the floating region 360 has not moved while the principal content region 330 appears to have moved in accordance with the scroll bar 315. The floating region 360 therefore may appear to float.

The document shown in dynamic document display 310 may be may be delivered to a display device, e.g., user device 126, fully constructed by a server, e.g., data processing system 150, or in pieces to be assembled at the display device. In some implementations, each content region of the display may be delivered separately. For example, the publisher content region 320 may be populated by an accelerated data server or cache, the principal content region 330 may be populated by a publishing server, e.g., a content publisher 120, and the supplemental content regions 340, 350, 360 may be populated by another data server, e.g., a supplemental content provider 122. In some implementations, a base document is delivered by the data processing system 150 to the user device 126 and the base document instructs the user device 126 to fetch various portions of the document from the appropriate servers. In some implementations, the base document includes content for one or more regions, e.g., publisher content for the publisher region 320.

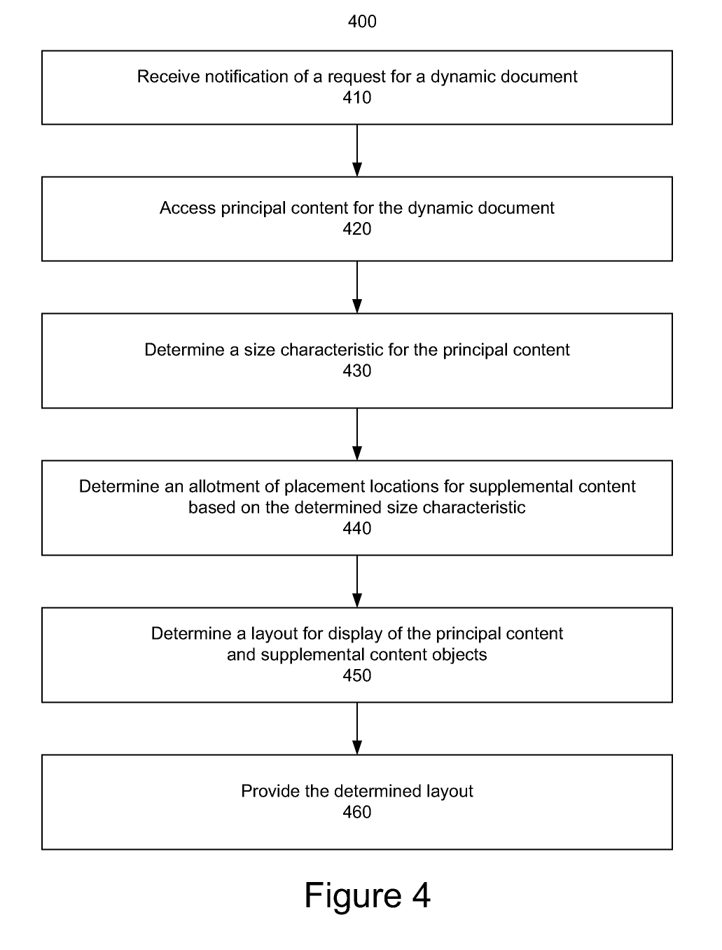

Referring to FIG. 4, a flowchart 400 illustrates a method for determining a layout for display of a dynamic document. Generally, at step 410, a data processing system 150 receives notification of a request for a dynamic document. At step 420, the data processing system 150 accesses principal content for the dynamic document. At step 430, the data processing system 150 determines a size characteristic for the principal content. At step 440, the data processing system 150 determines an allotment of placement locations for supplemental content based on the determined size characteristic. At step 450, the data processing system 150 determines a layout for display of the principal content and supplemental content objects. At step 460, the data processing system 150 provides the determined layout, e.g., to a user device 126 via the network 110.

At step 410, a data processing system 150 receives notification of a request for a dynamic document. For example, a user device 126 issues a request for a web page and the data processing system 150 is notified of the request. In some implementations, the request may be initially directed to a web server, which then notifies the data processing system 150. In some implementations, the request may be directed to the data processing system 150. The notification may be received, e.g., via the network 110.

At step 420, the data processing system 150 accesses principal content for the dynamic document. The request for the dynamic document may indicate a variety of content elements to be incorporated into the dynamic document. The data processing system 150 uses a portion of the content, referred to herein as the principal content, for determining and allocating other portions of the dynamic document. The data processing system 150 may retrieve the principal content from a server, e.g., from the content publisher 120. The data processing system 150 may access the principal content without retrieving the content. For example, the data processing system 150 may access the principal content and retrieve only the information necessary for method 400. That is, if the only information needed is a size characteristic, the data processing system 150 may access the principal content and retrieve only a character count. In some implementations, the data processing system 150 retrieves the principal content and caches it, e.g., in a database 170 local to the data processing system 150. Subsequent requests for the content may be accelerated using the cached copy.

At step 430, the data processing system 150 determines a size characteristic for the principal content. The size characteristic may be a length for the principal content. The size characteristic may be a number of characters, a number of words, a number of lines, a number of pixels, a dimension, or some other value indicating a size for the principal content. The size characteristic may be determined by the data processing system 150 by an analysis of data retrieved at step 420.

At step 440, the data processing system 150 determines an allotment of placement locations for supplemental content based on the determined size characteristic. In some implementations, the number of placement locations allotted may be determined to fill a supplemental content region 340 with enough supplemental content objects to match the length of the principal content 335, as indicated by the determined size characteristic. In some implementations, the number of placement locations allotted may be determined based on a spacing rule. An example spacing rule would only allow for one placement location per paragraph or sub-section of principal content. Another example spacing rule would only allow for one placement location per a set number of words of principal content, e.g., one placement location every 500 words.

In some implementations, the allotment of placement locations may also be based on a characteristic of the user. A characteristic of the user may be that the user is anonymous, is registered, is a paid subscriber, has a configuration setting, has a premium status, is a frequent visitor, is located in a known geographic region, is a certain age or in an age range, fits a demographic, has a history indicating preferences or interests, or any other characteristic on which allotment of placement locations may be based. In some implementations, a user may be enabled to establish preferences or configure the dynamic document. A user may have paid for the principal content and may therefore have an associated subscriber characteristic. A subscriber requesting an article from a news-oriented website may receive a layout with a different allotment of placement locations than would a non-subscriber requesting the same article. A subscriber may receive a greater or lesser number of supplemental content objects than a non-subscriber or anonymous user. For example, a subscriber may be entitled to receive fewer advertisements or to receive additional bonus content, e.g., background material for a story, an author's blog, or real-time event data (stock prices, sports scores, traffic, etc.).

Each of the above characteristics may be employed independently to determine the placement location allotment. Alternatively, any of the above characteristics can be employed as a parameter in a placement allotment determination that is based on a size characteristic of the principal content. For example, an anonymous user may receive an additional publisher content region encouraging registration and a dense allotment of placement locations designated for advertisements while a registered user may receive a less-dense allotment of placement locations with some placement locations designated for advertisements and other placement locations designated for bonus content. That is, a dynamic document presented to a first viewer having a first set of user characteristics may be allotted a greater number of placement locations per page, per line, per section or other size characteristic than a dynamic document having the same principal content presented to a different viewer with a different set of user characteristics.

At step 450, the data processing system 150 determines a layout for display of the principal content and supplemental content objects. The determined layout may be a template, an HTML page, a set of frames, a data object, a set of data objects, or a selection from a set of pre-defined layouts. The determined layout includes a number of supplemental content placement locations corresponding to the determined allotment. For example, if the data processing system 150 determines at step 440 that three placement locations for supplemental content should be allotted for the requested dynamic document, then the layout includes three placement locations. The placement locations may be grouped into a region, for example, as illustrated in FIG. 3A wherein the placement locations 345 are grouped into a supplemental content region 340. The placement locations may be spread throughout the document, for example, as illustrated in FIG. 3B wherein the placement locations may be within each of the supplemental content insets 350a-350n.

At step 460, the data processing system 150 provides the determined layout, e.g., to a user device 126 via the network 110. In some implementations, the layout is provided as a template. In some implementations, the layout is selected from an enumerated set of layout options and the layout number is provided. The layout may be provided directly to the user device 126. The layout may be provided to a document server, e.g., the content publisher 120. In some implementations the data processing system 150 uses the provided layout to generate the dynamic document and delivers the dynamic document, e.g., to the requesting user device 126.

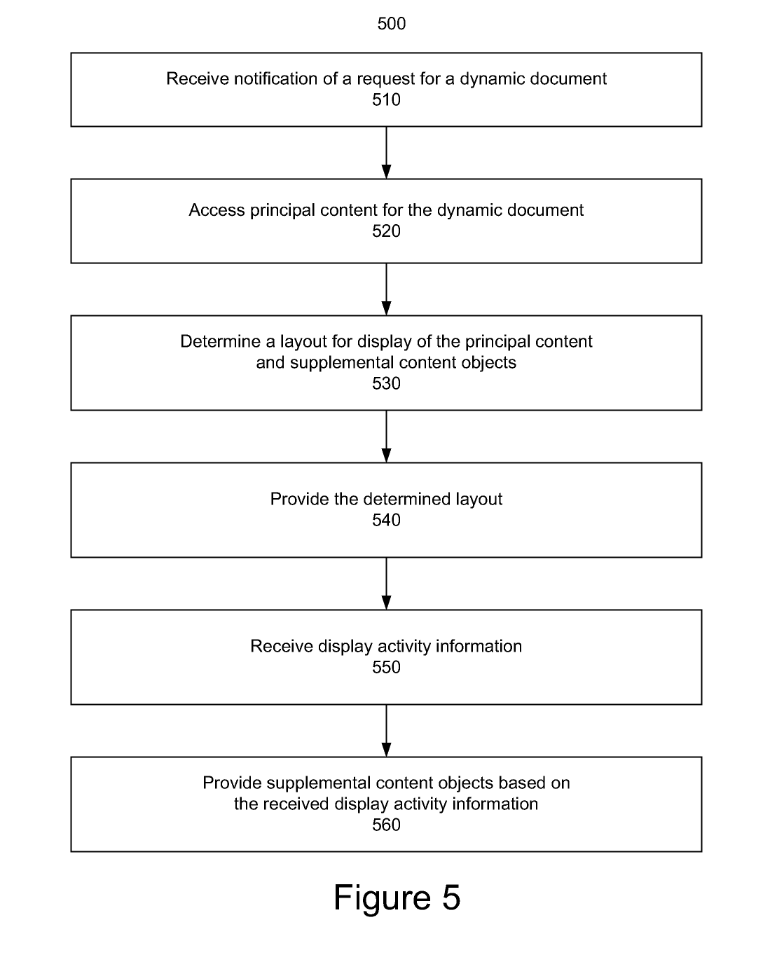

Referring to FIG. 5, a flowchart 500 illustrates a method of providing dynamically selected supplemental content objects for display with a dynamic document. Generally, at step 510, a data processing system 150 receives notification of a request for a dynamic document. At step 520, the data processing system 150 accesses principal content for the dynamic document. At step 530, the data processing system 150 determines a layout for display of the principal content and supplemental content objects. At step 540, the data processing system 150 provides the determined layout, e.g., to a user device 126. At step 550, the data processing system 150 receives display activity information, e.g., from the user device 126. At step 560, the data processing system 150 provides supplemental content objects, e.g., to the user device 126, based on the received display activity information.

At step 510, a data processing system 150 receives notification of a request for a dynamic document. For example, a user device 126 issues a request for a web page and the data processing system 150 is notified of the request. In some implementations, the request may be initially directed to a web server, which then notifies the data processing system 150. In some implementations, the request may be directed to the data processing system 150. The notification may be received, e.g., via the network 110.

At step 520, the data processing system 150 accesses principal content for the dynamic document. Access may be performed as described in reference to step 420. In some implementations, a document analysis module 154 accesses the principal content. In some implementations, the supplemental content module 158 uses information extracted from an analysis of the principal content in selecting supplemental content objects.

At step 530, the data processing system 150 determines a layout for display of the principal content and supplemental content objects. The layout may be determined as described in method 400. In some implementations, the layout includes components to support monitoring user interaction with the displayed dynamic document. For example, a display object may transmit information when a cursor or pointing device hovers over elements of the document or when a scroll bar, e.g., the scroll bar 315 illustrated in FIGS. 3A-3D, is activated. In some implementations, the layout includes one or more components to support transmitting display activity information, including monitored user interaction, back to the data processing system 150.

At step 540, the data processing system 150 provides the determined layout, e.g., to a user device 126. The layout may be provided as described in reference to step 460.

At step 550, the data processing system 150 receives display activity information, e.g., from the user device 126. For example, objects incorporated in the layout may transmit display activity information as described in reference to step 530. In some implementations, the data processing system 150 receives display activity information from a display module, a web browser, a display device, or a display activity monitor. Display activity information may include monitored user interaction, display events such as completion of a media sequence, and environmental events such as a display device turning off. For example, the data processing system 150 may receive information that a video has finished playing, that a song has ended, that a user has hovered the mouse over a portion of the display for an extended period of time, or that the display screen has been disabled.

At step 560, the data processing system 150 provides supplemental content objects, e.g., to the user device 126, based on the received display activity information. A supplemental content object may be a text, a graphic, a media object, an interactive object, or a dynamic document. For example, a supplemental content object may be a click-able image, which, when clicked, opens a dynamic document with additional information. The data processing system 150 may provide an initial set of one or more supplemental content objects with the layout provided at step 540. The data processing system 150 may provide a subsequent set of one or more supplemental content objects responsive to display activity information received at step 550. For example, a user may highlight a term in the principal content and, responsive to the highlighting, the data processing system 150 may provide a supplemental content object relevant to the highlighted term. In another example, a user may scroll display of the principal content and, responsive to the scrolling, the data processing system 150 may provide a refreshed set of supplemental content objects. In another example, the data processing system 150 may provide a refreshed set of supplemental content objects based on the passage of time. The data processing system 150 may provide updates to a set of supplemental content objects for specific placement locations.

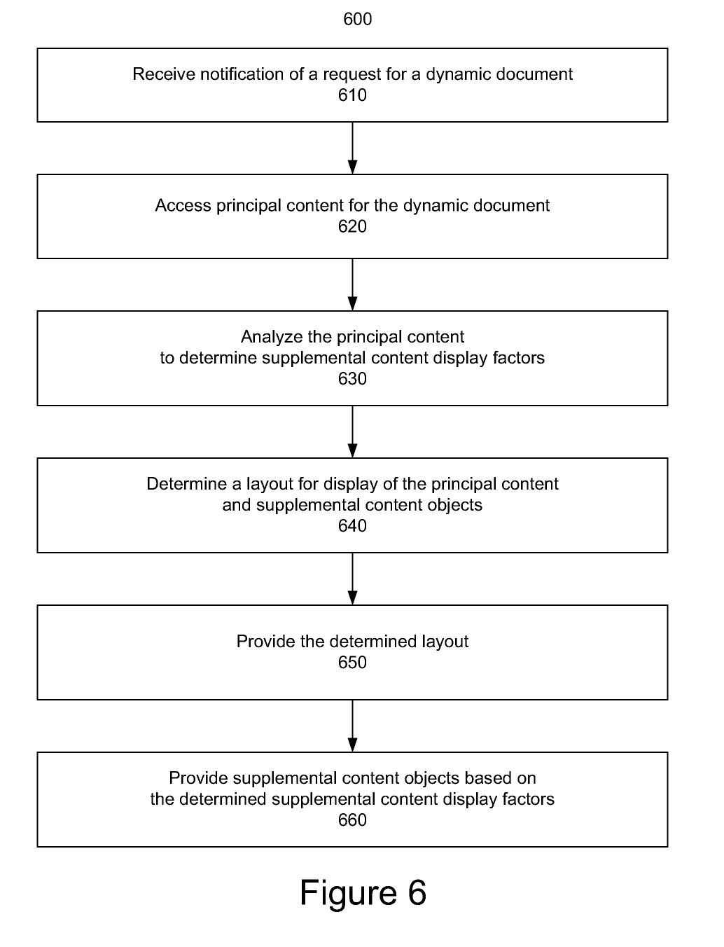

Referring to FIG. 6, a flowchart 600 illustrates a method of providing supplemental content objects for dynamic display with a dynamic document. Generally, at step 610, a data processing system 150 receives notification of a request for a dynamic document. At step 620, the data processing system 150 accesses principal content for the dynamic document. At step 630, the data processing system 150 analyzes the principal content to determine supplemental content display factors. At step 640, the data processing system 150 determines a layout for display of the principal content and supplemental content objects. At step 650, the data processing system 150 provides the determined layout, e.g., to a user device 126. At step 660, the data processing system 150 provides supplemental content objects, e.g., to the user device 126, based on the determined supplemental content display factors.

At step 610, a data processing system 150 receives notification of a request for a dynamic document. Notification may be received as described in reference to step 410 and step 510. At step 620, the data processing system 150 accesses principal content for the dynamic document. Access may be performed as described in reference to step 420 and step 520.

At step 630, the data processing system 150 analyzes the principal content to determine supplemental content display factors. Supplemental content display factors are aspects of the principal content that may factor into what supplemental content is displayed and when that content is displayed. In some implementations, a document analysis module 154 parses the principal content. In some implementations, the data processing system 150 identifies keywords, anchor points, section breaks, subject matter vectors, and content transitions. A statistical analysis of the principal content may yield additional information useful in selecting supplemental content objects. In some implementations, the supplemental content module 158 performs some or all of the functions of the document analysis module 154.

At step 640, the data processing system 150 determines a layout for display of the principal content and supplemental content objects. At step 650, the data processing system 150 provides the determined layout, e.g., to a user device 126. The layout may be determined and provided as described in reference to method 400 and method 500.

At step 660, the data processing system 150 provides supplemental content objects, e.g., to the user device 126, based on the determined supplemental content display factors. In some implementations, the supplemental content module 158 selects the supplemental content objects to provide based on the portion of the principal content closest to the destination region for the supplemental content object. For example, referring back to FIG. 3B, the supplemental content objects in each of the supplemental content insets 350a-350n may be selected based on the principal content 335 most proximate to the respective inset 350a-350n. In some implementations, the supplemental content module 158 selects the supplemental content objects to provide based on the portion of the principal content visible in the dynamic document display. For example, referring back to FIG. 3D, the supplemental content objects in the placement locations 365a-365n of the floating region 360 may be selected based on the principal content between the upper dashed line 316 and lower dashed line 318. As another example, the supplemental content objects in the placement locations 365a-365n of the floating region 360 may be selected based on a section of the principal content displayed between the upper dashed line 316 and lower dashed line 318, e.g., as designated by a section header, a content anchor, a paragraph mark, or a page break. The supplemental content objects may be selected, for example, based on supplemental content display factors, user characteristics, or commercial objectives. In some implementations, a supplemental content object is selected based on a value of the object. The value of an object may be relative to the principal content, to the user or user characteristics, to the display, or to other supplemental content objects currently displayed or under consideration for display.

In some implementations, the supplemental content objects in the floating region 360 are changed during display of the dynamic document. For example, the supplemental content objects may be changed as the user scrolls through the principal content, e.g., using scroll bar 315. The supplemental content objects may be changed responsive to the resulting displayed principal content or responsive to principal content remaining to be displayed. In some implementations, supplemental content objects in placement locations or supplemental content regions are changed over time without regard to user interaction. For example, a supplemental content object may be updated after being displayed for a document-specific, placement location-specific, or object-specific length of time, e.g., after the document has been displayed for 30 seconds, after the placement location has been within the view space for 30 seconds, or after the object has been displayed for 30 seconds. In some implementations, each placement location or supplemental content object may be configured with its own display time such that a first object may display for a longer period of time than a second object.

In some implementations, a set of supplemental content objects are displayed in a placement location in a sequence, which may be repeating or non-repeating. Each supplemental content object in the sequence may be displayed for an object-specific period of time, or each object in the sequence may be displayed for the same period of time. For example, a placement location may host three different supplemental content objects, one at a time, in a rotation, each for 20 seconds such that after a minute all three objects have been displayed and the first object would be displayed again.

In some implementations, user activity extends the time periods or pauses the measurement of time. For example, in some implementations, the supplemental content objects do not change while a user is actively scrolling the page, moving a mouse, or manipulating a pointer. In some implementations a supplemental content object is replaced if the user is interacting with a different region of the document or with a display element other than the dynamic document.

Referring back to FIG. 2, as introduced above, the computer system or computing device 200 may be employed to implement any of the computer systems discussed herein, in accordance with some implementations, including implementation of the system 100, content publisher 120, supplemental content provider 122, user device 126, data processing system 150, document analysis module 154, supplemental content module 158, database (or repository) 170, and any other computer system used. The computer system 200 can be used to provide information via the network 110 and to evaluate data, e.g., to determine Boolean query expressions, to identify documents satisfying query expressions, to determine relevance scores for documents satisfying query expressions, and to use the scores to identify content to provide for display with a web page.

The computer system 200 of FIG. 2 comprises one or more processors 250 communicatively coupled to memory 270 and one or more communication or network interfaces 210. Generally, the computer system 200 includes an I/O interface for receiving input via one or more input devices 224 (e.g., a keyboard, mouse, or touch screen) and producing output to one or more output devices 226 (e.g., a display, a screen, a touch screen, or speakers). The processors 250 can be included in the data processing system 150 or the other components of the system 100 such as the document analysis module 154, the document layout module 156, or the supplemental content module 158.

In the computer system 200 of FIG. 2, the memory 270 may include any non-transitory computer-readable storage media, and may store computer instructions such as processor-executable instructions for implementing the various functionalities described herein for respective systems, as well as any data relating thereto, generated thereby, or received via the communications interface(s) or input device(s) (if present). The processor(s) 250 shown in FIG. 2 may be used to execute instructions stored in the memory 270 and, in so doing, also may read from or write to the memory 270, and to cache memory 275, various information processed and or generated pursuant to execution of the instructions.

The processor 250 of the computer system 200 shown in FIG. 2 also may be communicatively coupled to or control the communication or network interface(s) 210 to transmit or receive various information pursuant to execution of instructions. For example, the network interface(s) 210 may be coupled to a wired or wireless network, bus, or other communication means and may therefore allow the computer system 200 to transmit information to and/or receive information from other devices (e.g., other computer systems). While not shown explicitly in the system of FIG. 1, one or more communications interfaces facilitate information flow between the components of the system 100. In some implementations, the communications interface(s) may be configured (e.g., via various hardware components or software components) to provide a website as an access portal to at least some aspects of the computer system 200.

The input device(s) 224 may be provided, for example, to allow a user to make manual adjustments, make selections, enter data or other information, or interact in any of a variety of manners with the processor during execution of the instructions. The output devices 226 of the computer system 200 shown in FIG. 2 may be provided, for example, to allow information to be viewed or otherwise perceived in connection with execution of the instructions. The input device 224 and the output device 226 may be the same device, such as a touch screen interface.

The processor 250 of the computer system 200 shown in FIG. 2 also may be communicatively coupled to one or more peripheral interfaces 230, e.g., a USB device, memory, disk drive, printer, or media device (e.g., a CD, DVD, or Blu-Ray player). Peripherals may be external to the computer system 200, separated by an interface (e.g., a USB interface) or housed within the computer system 200 and more closely connected, (e.g., a SCSI hard-disk drive).

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer-readable storage media for execution by, or to control the operation of, data processing apparatus. The program instructions can be encoded on an artificially generated propagated signal, e.g., a machine-generated electrical, optical, or electromagnetic signal that is generated to encode information for transmission to suitable receiver apparatus for execution by a data processing apparatus. A computer-readable storage medium can be, or be included in, a computer-readable storage device, a computer-readable storage substrate, a random or serial access memory array or device, or a combination of one or more of them. Moreover, while a computer-readable storage medium is not a propagated signal, a computer-readable storage medium can be a source or destination of computer program instructions encoded in an artificially generated propagated signal. The computer-readable storage medium can also be, or be included in, one or more separate physical components or media (e.g., multiple CDs, disks, or other storage devices).

Some of the features disclosed herein may be implemented on a smart television module (or connected television module, hybrid television module, etc.), which may include a processing circuit configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services (e.g., Netflix, Vudu, Hulu, etc.), a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate implementations, the features may be implemented on a laptop computer or other personal computer, a smartphone, other mobile phone, handheld computer, digital pad, tablet PC, or other computing device.

The operations described in this specification can be implemented as operations performed by a data processing apparatus on data stored on one or more computer-readable storage devices or received from other sources. The term “data processing apparatus” or “computing device” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. The document analysis module 154, document layout module 156, and the supplemental content module 158 can include or share one or more data processing apparatuses, computing devices, or processors.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), for example. Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a LCD (liquid crystal display) monitor, LED or OLED screen, a CRT (cathode ray tube), a plasma screen, or a projector, for displaying information to the user and a touch screen, keyboard, or a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system such as system 200 or system 100 can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination. Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated in a single software product or packaged into multiple software products.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements. References to “or” may be construed as inclusive so that any terms described using “or” may indicate any of a single, more than one, and all of the described terms.

Thus, particular implementations of the subject matter have been described. Other implementations are within the scope of the following claims.

What is claimed is:

1. A computer implemented method of determining a layout for display of a dynamic document, the method comprising:
accessing, by a data processing system, principal content for a dynamic document;
determining, by the data processing system, a size characteristic of the principal content;
determining, by the data processing system, a supplemental content slot for placement based on the determined size characteristic of the principal content;
determining, by the data processing system, a layout for display of the principal content and the supplemental content slot;
selecting, by the data processing system, a first supplemental content object for the supplemental content slot based on the principal content;
serving the determined layout and the selected first supplemental content object to a client device for presentation with a first portion of the principal content of the dynamic document, the first portion of the principal content of the dynamic document visible via a display of the client device and a second portion of the principal content of the dynamic document not visible via the display of the client device;
receiving, by the data processing system responsive to scrolling activity information from the client device, a request to refresh the supplemental content slot with a different supplemental content object, the scrolling activity information causing the second portion of the principal content to be visible;
selecting, by the data processing system responsive to the request, a second supplemental content object for the supplemental content slot, the second supplemental content object different from the first supplemental content object;
serving, responsive to the scrolling activity information, the selected second supplemental content object for placement in the supplemental content slot, the selected second supplemental content object presented with the second portion of the principal content of the dynamic document and replacing the served selected first supplemental content object in the supplemental content slot, wherein, responsive to the scrolling, the second portion of the principal content of the dynamic document is visible via the display and the first portion of the principal content of the dynamic document is not visible via the display;
receiving, by the data processing system responsive to subsequent scrolling activity information from the client device, a second request to refresh the supplemental content slot with a different supplemental content object, the scrolling activity information causing the first ortion of the srinci sal content to be visible;
selecting, by the data processing system responsive to the second request, a third supplemental content object for the supplemental content slot, the third supplemental content object different from the second supplemental content object and the first supplemental content object; and
serving, responsive to the subsequent scrolling activity information, the selected third supplemental content object for placement in the supplemental content slot, the selected third supplemental content object presented with the first portion of the principal content of the dynamic document and replacing the served selected second supplemental content object in the supplemental content slot, wherein, responsive to the subsequent scrolling, the first portion of the principal content of the dynamic document is visible via the display and the second portion of the principal content of the dynamic document is not visible via the display.

2. The method of claim 1, further comprising fetching the principal content, by the data processing system, from a second data processing system.

3. The method of claim 1, wherein the size characteristic of the principal content is one of a character count, a word count, or a line count.

4. The method of claim 1, wherein the size characteristic of the principal content is one of a pixel count, a media dimension, or a media element count.

5. The method of claim 1, further comprising:
receiving, by a data processing system, an indicator of a size characteristic of a display window; and
determining the size characteristic of the display window.

6. The method of claim 5, wherein determining the supplemental content slot is further based at least on the size characteristic of the display window.

7. The method of claim 5, wherein determining the layout for display of the principal content and the supplemental content slot is further based at least on the size characteristic of the display window.

8. The method of claim 1, wherein determining the layout further comprises positioning a placement location for the supplemental content slot according to a determined allotment of placement locations.

9. The method of claim 8, further comprising:
positioning the placement location of the supplemental content slot in a region that is one of:
a region inset within a principal content region;
a region adjacent to the principal content region;
a region configured to remain within a view; or
a region configured to float.

10. A system for determining a layout for display of a dynamic document, the system comprising:
a data processing system comprising a document layout module, the data processing system configured to:
identify a size characteristic of principal content for a document;
determine a supplemental content slot for placement based on the determined size characteristic of the principal content;
determine, using the document layout module, a layout for display of the principal content and the supplemental content slot;
select a first supplemental content object for the supplemental content slot based on the principal content;
serve the determined layout and the selected first supplemental content object to a client device for presentation with a first portion of the principal content of the dynamic document, the first portion of the principal content of the dynamic document visible via a display of the client device and a second portion of the principal content of the dynamic document not visible via the display of the client device;
receive, responsive to scrolling activity information from the client device, a request to refresh the supplemental content slot with a different supplemental content object, the scrolling activity information causing the second portion of the principal content to be visible;
select, responsive to the request, a second supplemental content object for the supplemental content slot, the second supplemental content object different from the first supplemental content object;
serve, responsive to the received scrolling activity information, the selected second supplemental content object for placement in the supplemental content slot, the selected second supplemental content object presented with the second portion of the principal content of the dynamic document and replacing the served selected first supplemental content object in the supplemental content slot, wherein, responsive to the scrolling, the second portion of the principal content of the dynamic document is visible via the display and the first portion of the principal content of the dynamic document is not visible via the display;
receive, responsive to subsequent scrolling activity information from the client device, a second request to refresh the supplemental content slot with a different supplemental content object, the scrolling activity information causing the first portion of the principal content to be visible;
select, responsive to the second request, a third supplemental content object for the supplemental content slot, the third supplemental content object different from the second supplemental content object and the first supplemental content object; and
serve, responsive to the subsequent scrolling activity information, the selected third supplemental content object for placement in the supplemental content slot, the selected third supplemental content object presented with the first portion of the principal content of the dynamic document and replacing the served selected second supplemental content object in the supplemental content slot, wherein, responsive to the subsequent scrolling, the first portion of the principal content of the dynamic document is visible via the display and the second portion of the principal content of the dynamic document is not visible via the display.

11. The system of claim 10, the data processing system further comprising a document analysis module, the data processing system further configured to fetch the principal content from a second data processing system and, using the document analysis module, identify the size characteristic through an analysis of the fetched principal content.

12. The system of claim 10, the data processing system further configured to:
receive an indicator of a size characteristic of a display window; and
determine the size characteristic of the display window.

13. The system of claim 12, wherein the data processing system is configured to determine the supplemental content slot based at least on the size characteristic of the display window.

14. The system of claim 12, wherein the document layout module is configured to determine the layout for display of the principal content and the supplemental content slot based at least on the size characteristic of the display window.

15. The system of claim 10, wherein the document layout module is further configured to determine the layout by positioning a placement location for the supplemental content slot according to a determined allotment of placement locations.

16. The system of claim 15, wherein positioning the placement location comprises positioning at least one placement location in a region that is one of:
a region inset within a principal content region;
a region adjacent to the principal content region;
a region configured to remain within a view; or
a region configured to float.

17. A non-transitory computer-readable storage media storing processor-executable instructions, which, when executed by one or more processors, cause the one or more processors to:
identify a size characteristic of principal content of a document;
determine a supplemental content slot for placement based on the determined size characteristic of the principal content;
determine a layout for display of the principal content and the supplemental content slot;
select a first supplemental content object for the supplemental content slot based on the principal content;
serve the determined layout and the selected first supplemental content object to a client device for presentation with a first portion of the principal content of the dynamic document, the first portion of the principal content of the dynamic document visible via a display of the client device and a second portion of the principal content of the dynamic document not visible via the display of the client device;
receive, responsive to scrolling activity information from the client device, a request to refresh the supplemental content slot with a different supplemental content object, the scrolling activity information causing the second portion of the principal content to be visible;
select, responsive to the request, a second supplemental content object for the supplemental content slot, the second supplemental content object different from the first supplemental content object and selected based on an updated portion of the principal near an updated placement of the supplemental content slot based on the scrolling activity information;
serve, responsive to the received scrolling activity information, the selected second supplemental content object for placement in the supplemental content slot, the selected second supplemental content object presented with the second portion of the principal content of the dynamic document and replacing the served selected first supplemental content object in the supplemental content slot, wherein, responsive to the scrolling, the second portion of the principal content of the dynamic document is visible via the display and the first portion of the principal content of the dynamic document is not visible via the display;
receive, responsive to subsequent scrolling activity information from the client device, a second request to refresh the supplemental content slot with a different supplemental content object, the scrolling activity information causing the first portion of the principal content to be visible;
select, responsive to the second request, a third supplemental content object for the supplemental content slot, the third supplemental content object different from the second supplemental content object and the first supplemental content object; and
serve, responsive to the subsequent scrolling activity information, the selected third supplemental content object for placement in the supplemental content slot, the selected third supplemental content object presented with the first portion of the principal content of the dynamic document and replacing the served selected second supplemental content object in the supplemental content slot, wherein, responsive to the subsequent scrolling, the first portion of the principal content of the dynamic document is visible via the display and the second portion of the principal content of the dynamic document is not visible via the display.

18. The computer-readable storage media of claim 17, the instructions further causing the one or more processors to:
receive an indicator of a size characteristic of a display window;
determine the size characteristic of the display window;
determine an allotment of placement locations for a plurality of supplemental content slots based at least on the size characteristic of the display window; and
determine the layout for display of the principal content and the plurality of supplemental content slots based at least on the size characteristic of the display window.

19. The computer-readable storage media of claim 17, the instructions further causing the one or more processors to determine the layout by positioning placement locations for supplemental content slots according to the determined allotment of placement locations.

20. The computer-readable storage media of claim 19, wherein positioning placement locations comprises positioning at least one placement location in a region that is one of:
a region inset within a principal content region;
a region adjacent to the principal content region;
a region configured to remain within a view; or
a region configured to float.
